(19) United States
(12) Patent Application Publication
(10) Pub. No.: US 2018/0040046 A1
(43) Pub. Date: Feb. 8, 2018

(54) SALES MANAGEMENT DEVICE, SALES MANAGEMENT SYSTEM, AND SALES MANAGEMENT METHOD

(71) Applicant: Panasonic Intellectual Property Management Co., Ltd., Osaka (JP)

(72) Inventors: Hiroki GOTOH, Osaka (JP); Takeshi WAKAKO, Kanagawa (JP)

(73) Assignee: PANASONIC INTELLECTUAL PROPERTY MANAGEMENT CO., LTD., Osaka (JP)

(21) Appl. No.: 15/554,102

(22) PCT Filed: Feb. 3, 2016
(86) PCT No.: PCT/JP2016/000542

§ 371 Date: Aug. 28, 2017

(30) Foreign Application Priority Data
Apr. 7, 2015 (JP) 2015-078182

(51) Int. Cl. G06Q 30/06; G06K 9/00; G10L 15/08; G06F 17/30; G10L 15/22

(52) U.S. Cl. CPC G06Q 30/0623; G06Q 30/0631; G06F 17/30976; G10L 15/22; G10L 15/08; G06K 9/00771; G06Q 20/20

(57) ABSTRACT

It is possible to manage a correlation between a presence and absence of a so-called up-selling talk, in which a clerk recommends that a customer buy an item, and a sales performance of the recommended item. A device includes a voice input unit that inputs a voice from a microphone in a store, a sales management unit that inputs sales data of the store, a storage unit that stores the sales data, a detector that detects whether or not a first keyword is included in the voice input to the voice input unit, and a determiner that determines whether or not the sales data is stored in the storage unit within a predetermined time from the time when it is detected by the detector that the first keyword is included.

### TECHNICAL FIELD

The present disclosure relates to a sales management device, a sales management system, and a sales management method for managing a correlation between a voice of a clerk when serving a customer and sales performance.

### BACKGROUND ART

In fast food stores such as hamburger shops and stores such as convenience stores, in order to prevent a customer from forgetting to buy something and to promote sales through occasion buying, it is known that it is effective for the store sales to perform a so-called up-selling talk, in which the clerk recommends that the customer buy some items at the time of cash register settlement.

As a technology of such an up-selling talk in the related art, a technology is known, in which, in a pub, an instruction to receive an order in addition to the menu ordered at a previous time is displayed on a handheld terminal of a clerk at a time earlier than an ordering time according to the previous history, and the clerk reads the instruction and goes to a target customer's table to urge the customer to order (refer to PTL 1). In addition, a technology is known, in which voice data of a conversation between the clerk and the customer is acquired and a keyword is extracted from the voice data (refer to PTL 2).

### CITATION LIST

### Patent Literature

PTL 1: Japanese Patent Unexamined Publication No. 2003-76757

PTL 2: Japanese Patent Unexamined Publication No. 2011-221683

### SUMMARY OF THE INVENTION

A sales management device of the present disclosure is configured to include: a voice input unit that inputs a voice from a microphone in a store; a sales management unit that inputs sales data of the store; a storage unit that stores the sales data; a detector that detects whether or not a first keyword is included in the voice input to the voice input unit; and a determiner that determines whether or not the sales data is stored in the storage unit within a predetermined time from the time when it is detected by the detector that the first keyword is included.

In addition, a sales management system in the present disclosure is configured to include: a microphone that collects voices in a store; and a microphone that collects voices in the store; and an information processing device that includes a processor and a memory. The information processing device includes a voice input unit that inputs a voice from a microphone in a store, a sales management unit that inputs sales data of the store, a storage unit that stores the sales data, a detector that detects whether or not a first keyword is included in the voice input to the voice input unit, and a determiner that determines whether or not the sales data is stored in the storage unit within a predetermined time from the time when it is detected by the detector that the first keyword is included.

In addition, a sales management method in the present disclosure is configured to include: detecting whether or not a first keyword including a recommended item name is included in a voice of a clerk input from a microphone in a store; and determining whether or not sales data of an item corresponding to the first keyword is stored within a predetermined time from the time when it is detected that the first keyword is included in the voice of the clerk.

According to the present disclosure, it is possible to determine whether or not a so-called up-selling talk, in which the clerk recommends that the customer to buy an item is actually performed, and whether or not the customer buys the item due to the up-selling talk. In this way, it is possible to manage a correlation between the up-selling talk and a sales performance.

### BRIEF DESCRIPTION OF DRAWINGS

FIG. 1 is an overall configuration diagram of a sales management system according to a first exemplary embodiment.

FIG. 2 is a hard block diagram of information processing device 10 according to the first exemplary embodiment.

FIG. 3 is a functional block diagram illustrating a schematic configuration of information processing device 10 according to the first exemplary embodiment.

FIG. 4 is an explanatory diagram illustrating a content of a table according to the first exemplary embodiment.

FIG. 5A is an explanatory diagram illustrating a content of a table in the first exemplary embodiment.

FIG. 5B is an explanatory diagram illustrating a content of a table according to the first exemplary embodiment.

FIG. 6A is an explanatory diagram illustrating a content of a table according to the first exemplary embodiment.

FIG. 6B is an explanatory diagram illustrating a content of a table according to the first exemplary embodiment.

FIG. 7 is an explanatory diagram illustrating a content of a table according to the first exemplary embodiment.

FIG. 8 is an operation flowchart illustrating a procedure for detecting keywords according to the first exemplary embodiment.

FIG. 9 is an operation flowchart illustrating a procedure for determination of a success or failure of an up-selling talk according to the first exemplary embodiment.

FIG. 10 is an operation flowchart illustrating a procedure for aggregating data according to the first exemplary embodiment.

FIG. 11 is an overall configuration diagram of a sales management system according to a second exemplary embodiment.

FIG. 12 is a functional block diagram illustrating a schematic configuration of information processing device 40 according to the second exemplary embodiment.

FIG. 13 is an explanatory diagram illustrating a content of a table according to the second exemplary embodiment.

FIG. 14A is an explanatory diagram illustrating a content of a table in the second exemplary embodiment.

FIG. 14B is an explanatory diagram illustrating a content of a table according to the second exemplary embodiment.

FIG. 15 is an operation flowchart illustrating a procedure for detecting a first keyword according to the second exemplary embodiment.

FIG. 16 is an operation flowchart illustrating a procedure for detecting a second keyword according to the second exemplary embodiment.

FIG. 17 is an operation flowchart illustrating a procedure for determination of a success or failure of an up-selling talk according to the second exemplary embodiment.

FIG. 18 is a functional block diagram illustrating a schematic configuration of information processing device 50 according to a third exemplary embodiment.

FIG. 19 is an explanatory diagram illustrating a content of a table according to the third exemplary embodiment.

FIG. 20 is an operation flowchart illustrating a procedure for determination of a success or failure of an up-selling talk according to the third exemplary embodiment.

FIG. 21 is a functional block diagram illustrating a schematic configuration of information processing device 60 according to a fourth exemplary embodiment.

FIG. 22 is an explanatory diagram illustrating a content of a table according to the fourth exemplary embodiment.

FIG. 23A is an explanatory diagram illustrating a content of a table in the fourth exemplary embodiment.

FIG. 23B is an explanatory diagram illustrating a content of a table according to the fourth exemplary embodiment.

FIG. 24 is an operation flowchart illustrating a procedure for acquiring customer information according to the fourth exemplary embodiment.

FIG. 25 is an operation flowchart illustrating a procedure for aggregating data according to the fourth exemplary embodiment.

FIG. 26 is an explanatory diagram illustrating an example of a screen displaying a data aggregation result according to the first to fourth exemplary embodiments.

FIG. 27 is an explanatory diagram illustrating an example of a screen displaying a data aggregation result in a plurality of stores according to the first to fourth exemplary embodiments.

FIG. 28 is an explanatory diagram illustrating an example of a screen displaying a data aggregation result according to the fourth exemplary embodiment.

### DESCRIPTION OF EMBODIMENTS

Prior to describing exemplary embodiments, the problems in the related art will be briefly described. In the technology disclosed in PTL 1 described above, it is possible to perform a sales promotion by recommending the customer's favorite menu based on the previous order history. However, there is a problem in that it is not possible to know whether or not the clerk actually recommended that the customer place orders, or whether or not the customer places additional orders according to the recommendation, and thus, it is not possible to check the effect of the up-selling talk.

In addition, in the technology disclosed in PTL 2, it is possible to extract a recommendable item from keywords included in the voice data in the conversation section with high customer's satisfaction. However, there is a problem in that it is not possible to know whether or not the clerk actually recommended that the customer places orders, or whether or not the customer places additional orders according to the recommendation, and thus, it is not possible to check the effect of the up-selling talk.

The present disclosure is derived for solving the problems in the related art described above, and the main object thereof is to provide a sales management device, a sales management system and a sales management method configured to manage a correlation between the presence or absence of a so-called up-selling talk, in which a clerk recommends that the customer buy an item, and the sales performance of the recommended item.

The first disclosure for solving the problems described above is configured to include: a voice input unit that inputs a voice from a microphone in a store; a sales management unit that inputs sales data of the store; a storage unit that stores the sales data; a detector that detects whether or not a first keyword is included in the voice input to the voice input unit; and a determiner that determines whether or not the sales data is stored in the storage unit within a predetermined time from the time when it is detected by the detector that the first keyword is included.

According to the configuration, since whether or not the sales of the item is stored within the predetermined time from an utterance of the predetermined keyword is determined, it is possible to manage the correlation between the predetermined keyword and the sales performance of the item.

In addition, the second disclosure is configured to include a voice input unit that inputs a voice from a microphone in a store; a sales management unit that inputs sales data of the store; a storage unit that stores the sales data; a detector that detects whether or not a first keyword is included in the voice input to the voice input unit; and a determiner that determines whether or not the sales data is stored in the storage unit in an accounting at the time when it is detected by the detector that the first keyword is included.

According to the configuration, since whether or not the sales of the item is stored is determined during the same accounting processing as when the predetermined keyword is uttered, it is possible to reliably manage the correlation between the predetermined keyword and the sales performance of the item.

In the third disclosure, the determiner is configured to determine whether or not sales data of an item corresponding to the first keyword is stored.

According to this configuration, since whether or not the item in association with the first keyword is sold is determined, it is possible to reliably manage the correlation between the predetermined keyword and the sales performance of the item.

In addition, the fourth disclosure is configured to include: a voice input unit that inputs voices of a clerk and a customer from a microphone in a store; a detector that detects whether or not a first keyword is included in the voice of the clerk and detects whether or not a second keyword is included in the voice of the customer; and a determiner that determines whether or not it is detected the second keyword is included within a predetermined time from the time when it is detected that the first keyword is included.

According to this configuration, by specifying the first keyword by the clerk and the second keyword by the customer, it is possible to manage the correlation between the first keyword and the sales performance of the item only by monitoring the voices.

In addition, in the fifth disclosure, the first keyword includes a recommended item name for the customer to be recommended to buy.

According to this configuration, whether or not the clerk recommends that the customer buy some items (up-selling talk) can be known, it is possible to manage the correlation between the up-selling talk of the clerk and the sales performance of the item.

In addition, in the sixth disclosure, the second keyword is a word affirming to buy the recommended item to the clerk.

According to this configuration, in a case where the customer uttered the word affirming to buy the recommended item after the clerk recommends that the customer to buy the item (up-selling talk), since it is assumed that the item is bought, it is possible to manage the correlation between the up-selling talk of the clerk and the sales performance of the item only by monitoring the voices.

In addition, in the seventh disclosure, the predetermined time is a time to finish one accounting.

According to this configuration, since the success of the up-selling talk is determined during the accounting processing for which the clerk recommends that the customer to buy the item (up-selling talk), it is possible to reliably manage the correlation between the up-selling talk of the clerk and the sales performance of the item.

In addition, the eighth disclosure is configured to include an evaluator that evaluates a clerk based on a result by the determiner.

According to this configuration, the number of successful up-selling talks can be calculated for each clerk, and can be used as an evaluation of the clerks. In addition, the success rate for each clerk is calculated from the number of uttered up-selling talks (number of up-selling talks) and the number of buyings due to the up-selling talks (the number of up-selling talks), and it is also possible to use this as the evaluation of the clerks.

In addition, the ninth disclosure is configured to further include an evaluator that evaluates a clerk; an image input unit that inputs an image of a customer from a camera in a store; and a recognizer that recognizes attributes of the customer based on the image. The evaluator is configured to aggregate the results of determination by the determiner for each attribute.

According to this configuration, since attributes such as an age or a gender of the customer is recognized from the image of the customer, and the number of successful up-selling talk and the success rate according to the age and the gender of the customer are aggregated, it is possible to grasp the age or the gender of the customer in which the up-selling talk is easy to succeed, and thus, it can be utilized in sales strategy. In addition, since the items for which the up-selling talk is successful is managed for each age and the gender of the customer, the items in which the up-selling talk is easy to succeed can be specified by the age or the gender of the customer, and it is possible to effectively perform the up-selling talk.

In addition, the tenth disclosure is configured to include: a microphone that collects voices in a store; and an information processing device that includes a processor and a memory. The information processing device includes: a voice input unit that inputs a voice from a microphone in a store; a sales management unit that inputs sales data of the store; a storage unit that stores the sales data; a detector that detects whether or not a first keyword is included in the voice input to the voice input unit; and a determiner that determines whether or not the sales data is stored in the storage unit within a predetermined time from the time when it is detected by the detector that the first keyword is included.

According to the configuration, since whether or not the sales of the item is stored within the predetermined time from an utterance of the predetermined keyword is determined, it is possible to manage the correlation between the predetermined keyword and the sales performance of the item.

In addition, the eleventh disclosure is configured to include: a microphone that collects voices in a store; and an information processing device that includes a processor and a memory. The information processing device is configured to include: a voice input unit that inputs voices of a clerk and a customer from a microphone in a store; a detector that detects whether or not a first keyword is included in the voice of the clerk and detects whether or not a second keyword is included in the voice of the customer; and a determiner that determines whether or not it is detected that the second keyword is included within a predetermined time from the time when it is detected that the first keyword is included.

According to this configuration, by specifying the first keyword by the clerk and the second keyword by the customer, it is possible to manage the correlation between the first keyword and the sales performance of the item only by monitoring the voices.

In addition, the twelfth disclosure is a method that includes: detecting whether or not a first keyword including a recommended item name is included in a voice of a clerk input from a microphone in a store; and determining whether or not sales data of an item corresponding to the first keyword is stored within a predetermined time from the time when it is detected that the first keyword is included in the voice of the clerk.

According to this configuration, since whether or not the sales of the item corresponding to the predetermined keyword is recorded within a predetermined time from the time when the predetermined keyword is uttered is determined, it is possible to manage the correlation between the predetermined keyword and the sales performance of the item.

In addition, the thirteenth disclosure is a method that includes: detecting whether or not a first keyword including a recommended item name is included in a voice of a clerk input from a microphone in a store; and determining whether or not a second keyword affirming to buy the recommended item is included in a voice of a customer within a predetermined time from the time when it is detected that the first keyword is included in the voice of the clerk.

According to this configuration, by detecting a customer's affirming response to the recommendation of the item by the clerk, it is possible to manage the correlation between the first keyword and the sales performance of the item only by monitoring the voice.

### First Exemplary Embodiment

Hereinafter, exemplary embodiments will be described referring to the drawings.

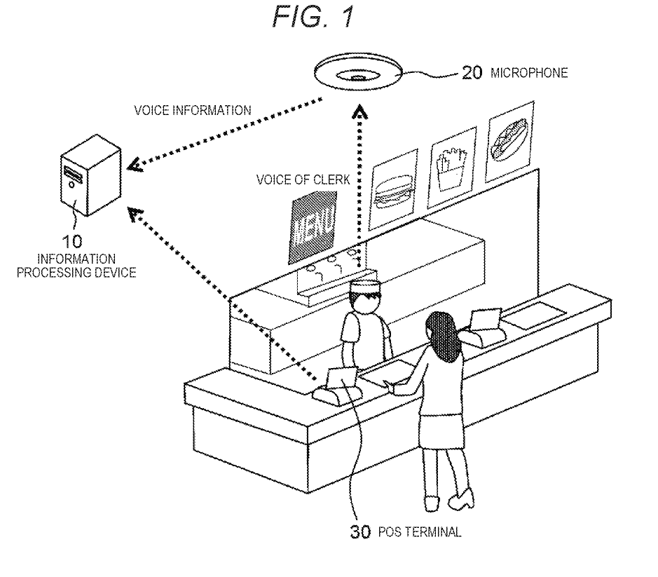

FIG. 1 is an overall configuration diagram of a sales management system in a first exemplary embodiment. This sales management system is a system built for a fast food store such as a hamburger shop or a retail chain store such as a convenience store, and includes information processing device (PC) 10, microphone 20, and POS terminal 30 that are provided in each of the plurality of stores. In addition, even not illustrated in FIG. 1, it is assumed that the system includes an information processing device (PC) provided in a headquarter that performs an overall management of a plurality of stores, a cloud computer that configures a cloud computing system provided on a network, and a smart phone or a tablet terminal that can receive evaluation information or analysis information at an arbitrary place, and a monitoring voice.

Microphone 20 is installed at an appropriate place in the store, and voices of the customer and the clerk are collected by microphone 20 and the voices obtained, thereby is accumulated in information processing device 10. The voices may be collected and accumulated at all the time or the collection of the voices may be started at the timing when the register operation is started as described below. In information processing device 10 installed in the store or the information processing device installed in the headquarters, or in the smart phone or the tablet terminal connected to those devices through the network, the voices collected by microphone 20 may be made to be heard in real time and the past voices accumulated in information processing device 10 may be made to be heard as well. In this way, it is possible to check the situation in the store even at the store, headquarters, or from the outside.

The information processing device installed in the headquarters is configured as a device supporting a work of a supervisor who manages a plurality of stores. In addition, information generated in the information processing device in the headquarters can be viewed by the supervisor through a monitor, and then, is transmitted to information processing device 10 installed in each store, and can be viewed from information processing device 10 in each store by store managers or the like. In addition, the smart phone or the tablet terminal connected to the network may be the viewing device.

Next, the overall configuration will be described referring to FIG. 1 with hamburger shop as an example.

Microphone 20 for collecting the voice of the clerk is installed in the store. Microphone 20 may be installed on a ceiling of the store or may be installed at the vicinity of the POS terminal. Alternatively, microphone 20 may be attached to a clerk's breast as a pin microphone, and any other microphones may be used as long as the voice of the clerk can be collected.

In addition, in the store, POS terminal (register terminal) 30 that performs accounting processing is installed on a register counter, and the clerk receives the customer's order and inputs the ordered items into the POS terminal. The clerk inputs his clerk ID into the POS terminal when starting the operation of the POS terminal, and thus, the clerk in charge of each accounting can be distinguished. The clerk ID may be automatically read in from a tag worn by the clerk even if it is not directly input. When inputting the ordered item is finished, a total amount is displayed on the POS terminal for causing the customer to make payment.

In addition, at an office of the store, information processing device 10 is installed and is connected to microphone 20 and POS terminal 30. The voices collected by microphone 20 are accumulated in information processing device 10 and sales data input to the POS terminal is also accumulated in information processing device 10.

In addition, although not illustrated in FIG. 1, a camera that images inside of the store may be installed in the store. Using the camera, the customer in front of the register counter can be imaged, and it is possible to acquire attributes such as an age, a gender, and the like of the customer.

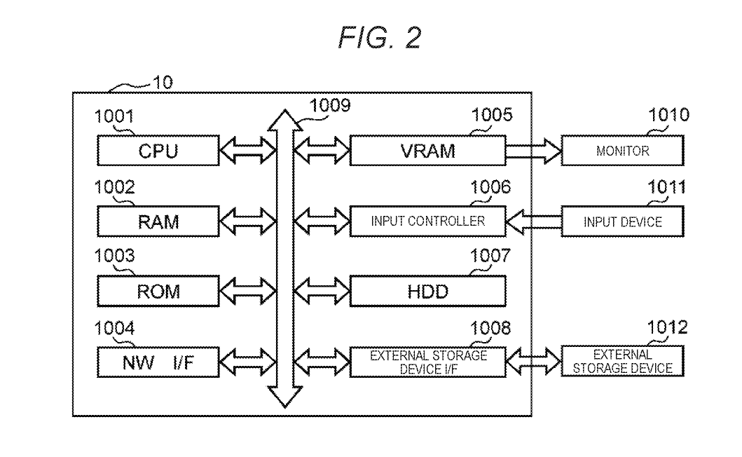

FIG. 2 is a hard block diagram of information processing device 10 installed in the store. Information processing device 10 includes central processing unit (CPU) 1001 that controls a computer system, random access memory (RAM) 1002, read only memory (ROM) 1003 that stores a program which is executed by the CPU and realizes operation processing procedures of a monitoring device and each functional configuration, network interface (NW I/F) 1004 that performs a transfer of data in an external device via the network, video RAM (VRAM) 1005 that displays image information on monitor 1010, input controller 1006 that controls an input signal input from input device 1011 configured with a keyboard or a pointing device, hard disk drive (HDD) 1007, external storage device interface 1008 that controls input and output from external storage device 1012, and bus 1009 that makes each units be connected to each other. The inputs from microphone 20 and POS terminal 30 are performed by network interface (NW I/F) 1004 via the network.

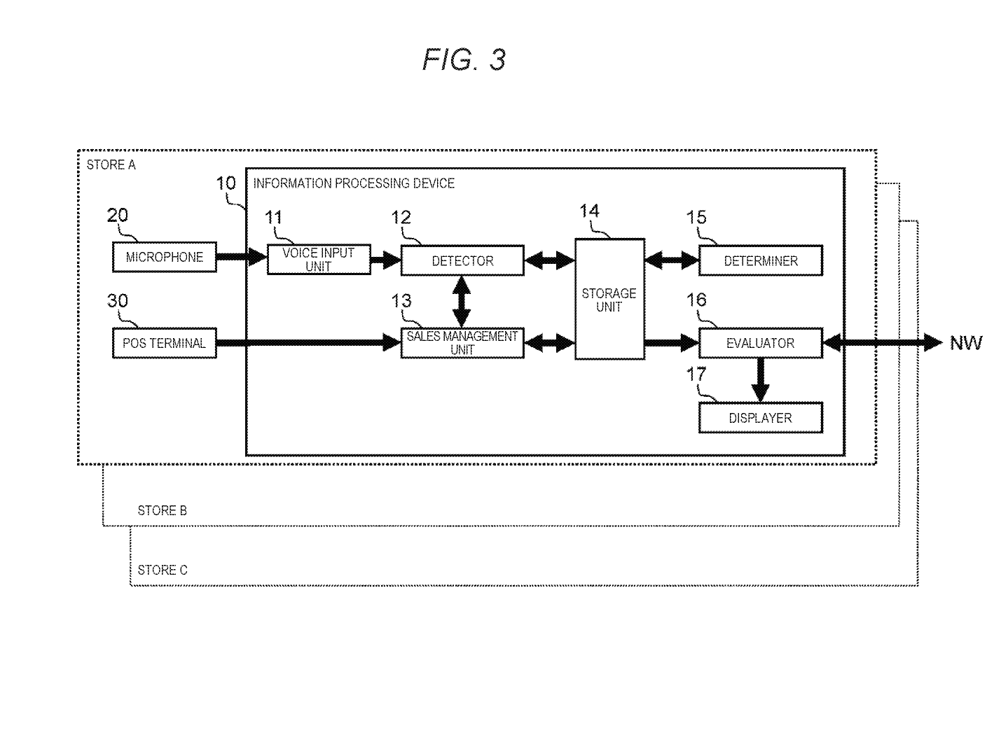

FIG. 3 is a functional block diagram illustrating a schematic configuration of information processing device 10 installed in the store. Information processing device 10 includes voice input unit 11 that inputs the voice collected by microphone 20, detector 12 that detects whether or not a predetermined keyword is included in the input voice by a voice recognition, sales management unit 13 that inputs the sales data input from POS terminal 30, storage unit 14 that stores necessary information, determiner 15 that determines the success or failure of the up-selling talk from the content stored in storage unit 14, evaluator 16 that performs evaluation of the clerks from the result of determination and outputs the evaluation information to the network, if necessary, and displayer 17 that displays the result of evaluation.

Each functional configuration illustrated in FIG. 3 is realized by CPU 101 illustrated in FIG. 2 executing the programs stored in ROM 103 for controlling each hardware. Those programs may be provided in information processing device 10 in advance and configured as dedicated devices. In addition, the programs may be recorded in an appropriate program recording medium as an application program operating on a general purpose OS. In addition, the program may be provided for a user via the network. In addition, the information processing device installed in the headquarters is configured similar to the information processing device 10 as well.

In FIG. 3, voice input unit 11 inputs the voice collected by microphone 20. Voice input unit 11 may input all the voices in the store or may input only the voice of the clerk depending on the installation position of microphone 20.

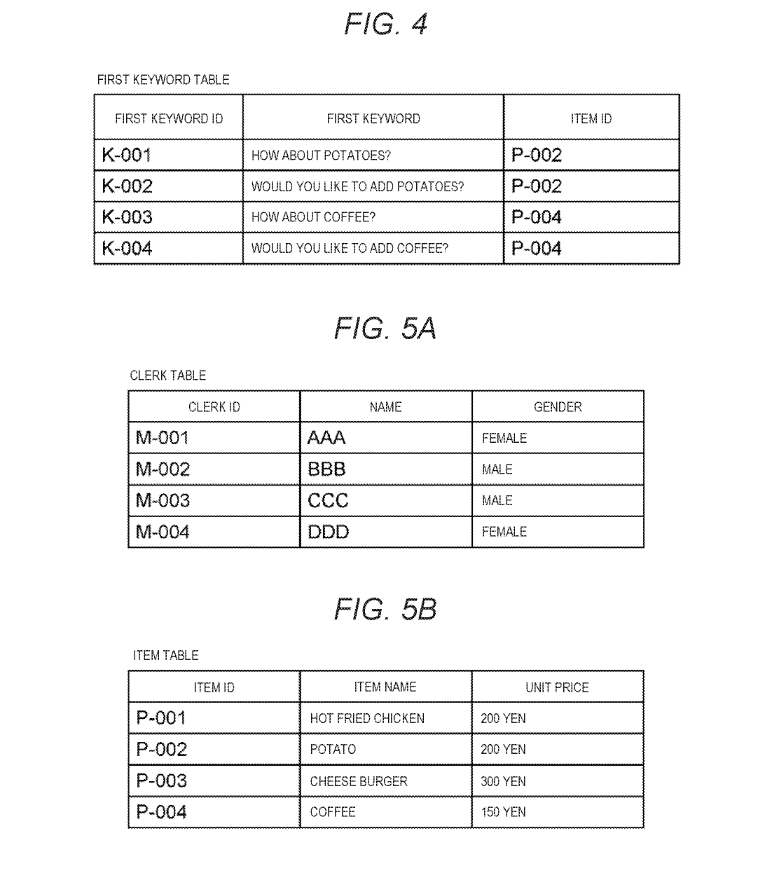

Detector 12 detects a predetermined keyword from the input voices using the voice recognition. As illustrated in FIG. 4, since the detected keyword (a first keyword) is stored in advance in a first keyword table in storage unit 14, detector 12 detects whether or not the keyword stored in the first keyword table is included in the input voice.

Here, the first keyword is a word used as the up-selling talk by the clerk such as “How about potatoes?”. The addition or change of the keywords in the first keyword table can be arbitrarily performed by the manager using text input or voice registration. In the example in FIG. 4, it is assumed that an ID (a first keyword ID) assigned to the keyword or an ID (an item ID) of an item corresponding to an item name included in the keyword may also be stored in the first keyword table.

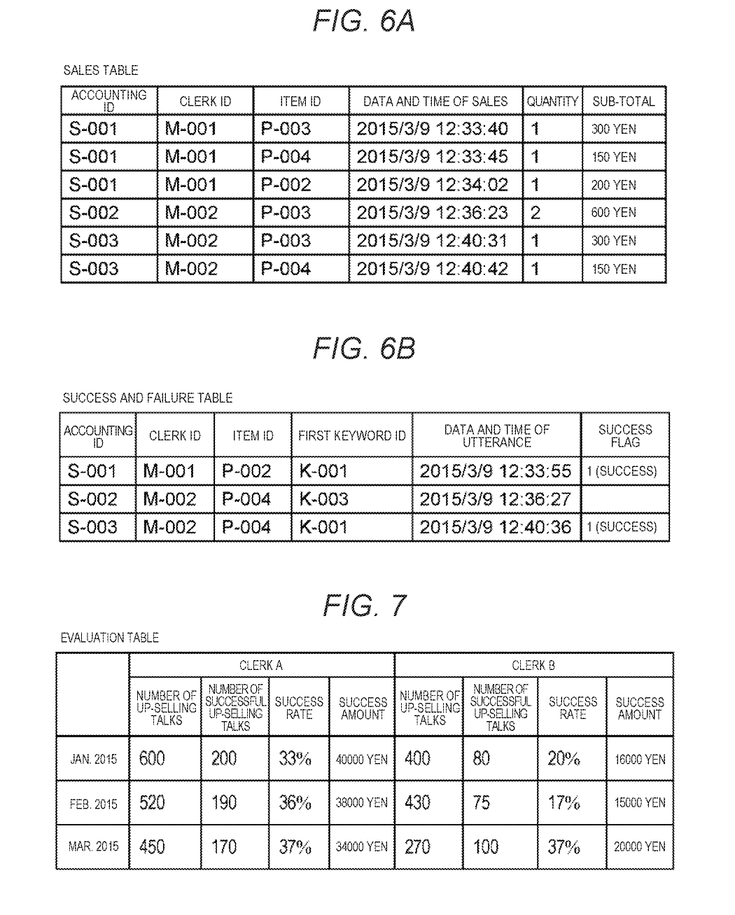

In a case where the first keyword is detected, detector 12 acquires the accounting ID or the clerk ID at the time of detection from sales management unit 13. The ID (the first keyword ID) of the detected first keyword, date and time of utterance, the item ID corresponding to the first keyword in the first keyword table, the accounting ID and the clerk ID at the time of detecting the first keyword are stored in a success and failure table in which the success and failure of the up-selling talk illustrated in FIG. 6B is stored.

Sales management unit 13 manages the sales data input from POS terminal 30. Information on the clerk operating POS terminal 30 is stored in advance in a clerk table in FIG. 5A. In addition, information on the ordered item is stored in advance in an item table in FIG. 5B. In addition, sales management unit 13 generates the clerk who performed the accounting and the item that is sold and the number of sales, amounts, and date and time of the sales for each accounting unit based on the sales data input from POS terminal 30, and stores the result in a sales table in FIG. 6A.

Detector 12 may stores only the first keyword ID, the date and time of the utterance, and the item ID in the success and failure table (FIG. 6B), may notify sales management unit 13 of the detection, and sales management unit may store the accounting ID and the clerk ID in the success and failure table.

Storage unit 14 stores the information in the first keyword table in FIG. 4, the clerk table in FIG. 5A, the item table in FIG. 5B, the sales table in FIG. 6A, the success and failure table in FIG. 6B, and an evaluation table in FIG. 7.

Determiner 15 compares the content of the sales table in FIG. 6A and the content of the success and failure table in FIG. 6B, and in a case where the date and time of the sales is present in the sales table within a predetermined time from the date and time of the utterance in the success and failure table, determiner 15 determines that the up-selling talk is successful, and then, stores “1 (success)” in a success flag in the success and failure table. The “predetermined time” here may be set as a standard time required for the clerk to input an additional order into POS terminal 30 from the time when the recommendation of “How about potatoes?” is given by the clerk and the customer requests an additional order. In this example, in a case where the up-selling talk is failed, nothing is stored in the success and failure table, but “0 (failure)” may be stored in the success flag.

In addition, in a case where sales data of the item ID same as the item ID in the success and failure table is present in the sales table within the predetermined time from the date and time of the utterance, determiner 15 may determine that the up-selling talk is successful. By using the item ID, it is possible to exclude a case where an item other than the recommended item is ordered even after the utterance of the up-selling talk.

Determiner 15 may determine that the up-selling talk is successful in a case where the sales data after the date and time of the utterance is present in the sales table in the sales data of the accounting ID same as the accounting ID in the success and failure table.

In addition, determiner 15 may determine that the up-selling talk is successful in a case where, after the date and time of the utterance, the sales data of the item ID same as the item ID in the success and failure table is present in the sales data in the sales table having the accounting ID same as the accounting ID in the success and failure table.

That is, in a case of using the accounting ID, the “predetermined time” is a time to the last date and time of the sales in one accounting processing (the same accounting ID). By using the accounting ID, it is possible to exclude a case where an order is received from the next customer after the utterance of the up-selling talk.

Evaluator 16 aggregates the number of performances of the up-selling talks (the number of up-selling talks) for each clerk and for each month, the number of successes of the sales using the up-selling talks (the number of successful up-selling talks), a success rate, a sales amount due to the up-selling talk (a success amount), and the like referring to the success and failure table or the like stored in storage unit 14, and then, generates an evaluation table illustrated in FIG. 7. The evaluation information based on the generated evaluation table can be transmitted to the information processing device and the smart phone or the tablet terminal in another store or in the headquarters via the network.

Displayer 17 displays the evaluation information on the monitor so as to be viewed by participants in the store.

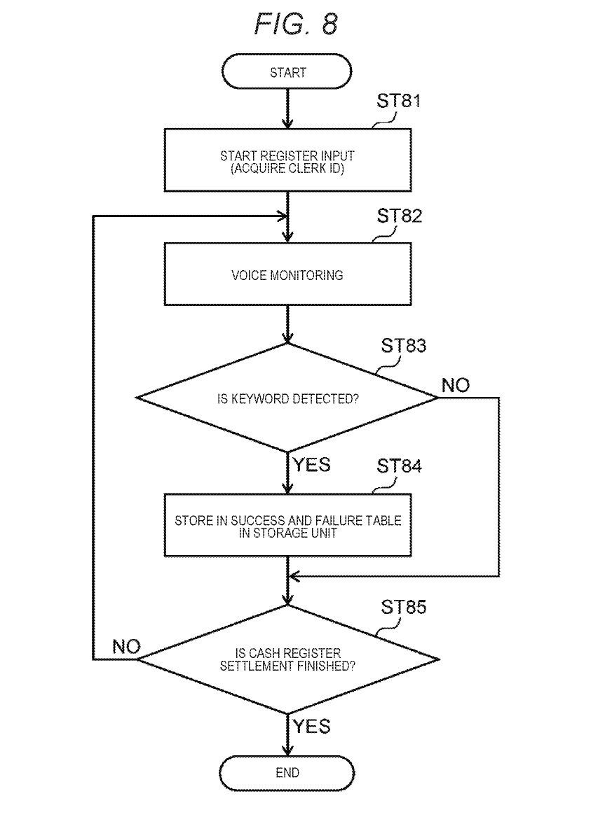

Next, an operation procedure performed by information processing device 10 will be described. FIG. 8 is an operation flowchart illustrating a procedure for detecting the keywords.

In FIG. 8, the clerk starts input to POS terminal 30 (register device). Here, when starting the register input, information for identifying the clerk is input to POS terminal 30, and thus, the clerk ID is acquired (ST81). The information relating to the clerk is stored in the clerk table (refer to FIG. 5A) in storage unit 14 as the information on the name, the gender, and the clerk ID of the clerk.

In addition, it is assumed that one accounting ID is assigned to a series of orders from the same customer for the management. Subsequently, the items ordered from the customer is input to POS terminal 30, and the sales data (the accounting ID, the clerk ID, the item ID, the date and time of the sales, quantity, amount and the like) is transmitted to sales management unit 13 in information processing device 10. The information relating to the items is stored in the item table in storage unit 14 (refer to FIG. 5B) as information on the item names, the item IDs, unit prices, or the like.

Sales management unit 13 stores the sales data acquired from POS terminal 30 in the sales table in FIG. 6A. The sales data may be collectively transmitted to information processing device 10 from POS terminal 30 on the predetermined timing basis such as a time point when the accounting ID is changed, when the clerk ID is changed, or one day basis.

Next, the voice monitoring is started and the voices collected by microphone 20 are input to voice input unit 11 (ST82). In the example here, the voice monitoring is started when the clerk ID is acquired. However, the voice monitoring may be performed all the time during the sales operation in the store.

Next, detector 12 recognizes the input voice, and detects whether or not the first keyword (up-selling talk) stored in the first keyword table in FIG. 4 is included therein (ST 83). When the keyword cannot be detected (No in ST83), ST82 to ST 83 are repeated until the cash register settlement for a series of orders from the same customer is finished. In a case where the clerk does not say up-selling talk, the cash register settlement is finished without the first keyword being detected.

In ST83, when the first keyword (up-selling talk) is detected (Yes in ST83), detector 12 stores the first keyword ID indicating which keyword stored in the first keyword table is detected, the item ID of the item associated with the first keyword, and the date and time of the utterance in the success and failure table in FIG. 6B (ST84). In addition, the accounting ID and the clerk ID acquired from sales management unit 13 are also stored in the success and failure table in FIG. 6B. Detector 12 may notify sales management unit 13 of the fact that the keyword is detected, and then, sales management unit 13 may store the accounting ID and the clerk ID in the success and failure table.

Specifically, a customer orders “a cheese burger (item ID: P-003)” and “a cup of coffee (item ID: P-004)” to a clerk AAA in charge of cash register. A spontaneous order from the customer is up to here, but the clerk AAA performs an up-selling talk saying “How about potatoes?” before finishing the cash register settlement. When the performance of the up-selling talk is detected, the date and time of the utterance and the like are stored in the success and failure table in FIG. 6B. In a case where the customer additionally orders a potato (item ID: P-002) upon receiving the up-selling talk, the item ID of P-003 (a cheese burger) and P-004 (a cup of coffee), and additionally ordered P-002 (a potato) are stored in the sales table in FIG. 6A under the same accounting ID of S-001. At this time, as a matter of course, the date and time of the sales of the potato in the sales table comes later than the time in the date and time of the utterance in the success and failure table.

Next, whether or not a series of orders from the customer is finished is determined (ST85), and in a case where the cash register settlement is not finished yet (No in ST85), the process returns to ST82 and the detection of the keyword is continued. A case where the customer continues to order another item after the additional order or a case where the clerk performs the second up-selling talk is assumed to be the case where the cash register settlement is not finished yet after the additional order becomes successful using the up-selling talk.

When the series of orders from the customer is finished and the first cash register settlement is finished (Yes in ST85), the keyword detection processing ends. Whether or not the cash register settlement is finished may be determined by sales management unit 13 acquiring information relating to a fact that the clerk performs an operation for calculating a total amount using POS terminal 30 or performs the finishing operation of the cash register settlement.

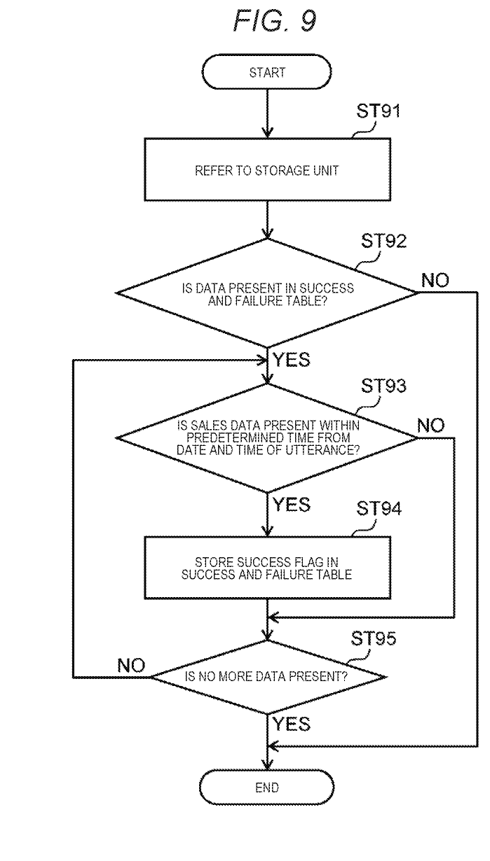

Next, an operation for determining the success or failure of the up-selling talk in information processing device 10 will be described. FIG. 9 is an operation flowchart illustrating a procedure for determination of a success or failure of an up-selling talk.

In FIG. 9, determiner 15 refers to storage unit 14 (ST91), and determines whether or not the data is present in the success and failure table (refer to FIG. 6A) stored in storage unit 14 (ST92). In a case where the data is not present (No in ST92), it means that the up-selling talk is not performed by the clerk and the process ends.

On the other hand, in a case where the data is present in the success and failure table (Yes in ST92), determiner 15 determines whether or not the sales data is present in the sales table (refer to FIG. 6A) within a predetermined time from the date and time of the utterance when the up-selling talk is performed (ST93). Here, the predetermined time may be set as a standard time required for the clerk to input the additional order into POS terminal 30 from the recommendation saying “How about potatoes?” from the clerk and the customer's request for the additional order. For example, in a case where the predetermined time is set to 10 seconds, in the first row of the success and failure table in FIG. 6B, the date and time of the utterance of the up-selling talk is “2015/3/9 12:33:55”, and in the third row of the sales table in FIG. 6A, the date and time of the sales is “2015/3/9 12:34:02”, and thus, it is determined that the sales data is present within 10 seconds. At this time, furthermore, the fact that the item ID in the sales data is same as the item ID in the success and failure table may be a condition for the determination. In addition, furthermore, the fact that the accounting ID in the sales data is same as the accounting ID in the success and failure table may be a condition of the determination.

In ST93, in a case where it is determined that the sales data is present within the predetermined time (Yes in ST93), the fact that there is an additional order due to the up-selling talk is regarded as the success of the up-selling talk, and for example, “1” is stored in the success and failure table as a success flag (ST94). In a case where it is determined that the sales data is not present (No in ST93), it means that there is no additional order due to the up-selling talk, and thus, nothing is stored in the success and failure table, and the process proceeds to ST95. Of course here, for example, “0” may be stored in the success and failure table as a failure flag.

Subsequently, it is determined whether or not a next data is still present in the success and failure table (ST95). In a case where the next data is present in the success and failure table, the process returns to ST93 to repeat the processing.

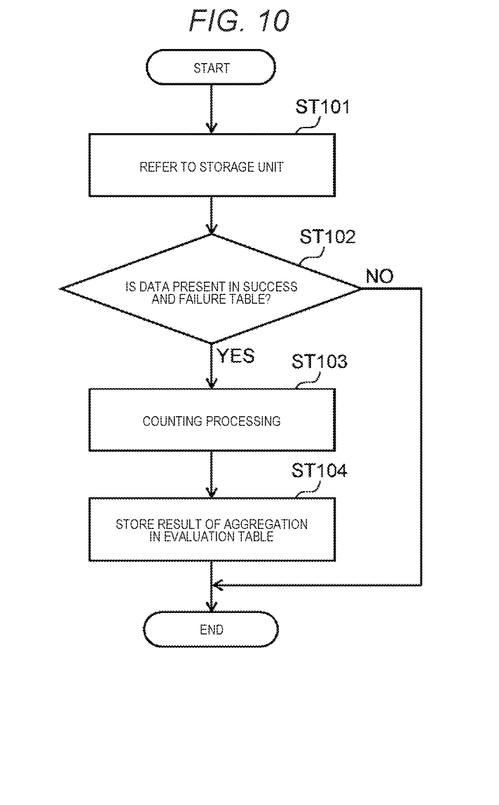

Next, an operation for aggregating the success and failure of the up-selling talks in information processing device 10 will be described. FIG. 10 is an operation flowchart illustrating a procedure for aggregating data.

In FIG. 10, evaluator 16 refers to storage unit 14 (ST101), and determines whether or not the data is present in the success and failure table (refer to FIG. 6B) stored in storage unit 14 (ST102). In a case where the data is not present (No in ST102), it means that the up-selling talk is not performed by the clerk and the process ends.

On the other hand, in a case where the data is present in the success and failure table (Yes in ST102), aggregation processing for aggregating the number of success flags “1 (success)” in the success and failure table is performed (ST103). Since the number of data items in the success and failure table is the number of times the clerk performs the up-selling talk, it is possible to calculate the “number of up-selling talks”, “the number of successful up-selling talks”, and the “success rate” from the total number of data items and the number of data items having the success flag 1 (success). In addition, since the item IDs are stored in the success and failure table, by collating these item IDs with the item table (refer to FIG. 5B), it is possible to calculate the success amount due to the successful up-selling talk. In addition, since the clerk ID and the date and time of the utterance are stored in the success and failure table, it is possible to perform the aggregation on a clerk basis or on a monthly basis from these information items.

Based on the result of aggregation, the evaluation information such as the evaluation table illustrated in FIG. 7 is generated (ST104), and then, the process ends. The evaluation information can be displayed on the monitor screen of information processing device 10 while various processing items such as a graphic display being executed. In addition, the evaluation information can be referred to using the information processing device installed in another store or in the headquarters via the network.

### Second Exemplary Embodiment

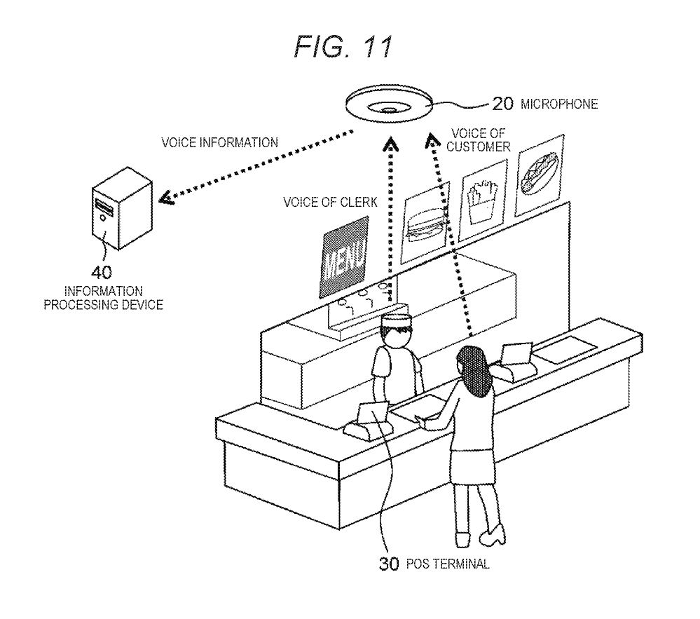

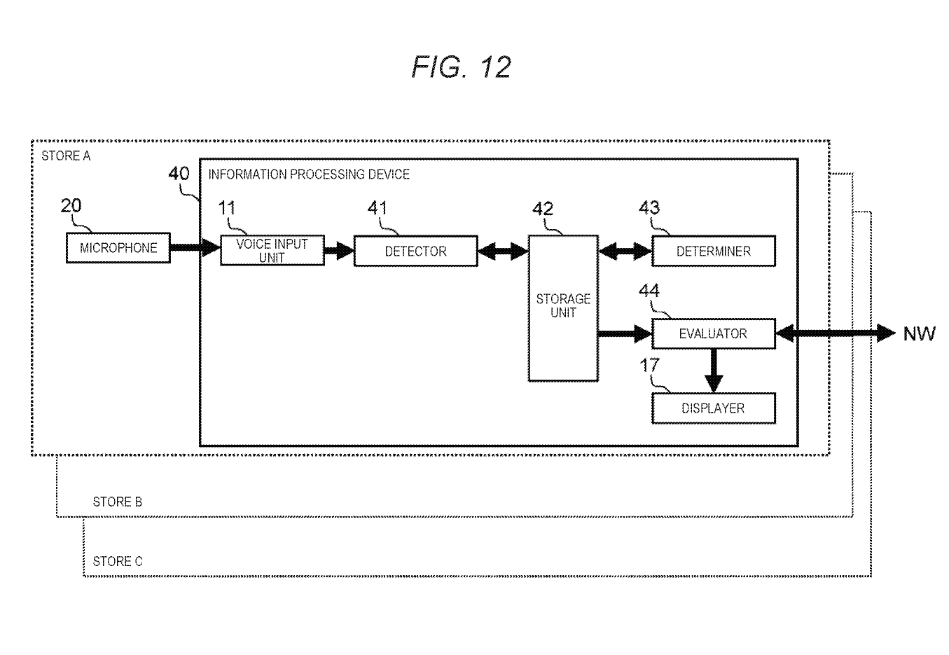

FIG. 11 is an overall configuration diagram of a sales management system in a second exemplary embodiment. Information processing device 40 in the second exemplary embodiment is not linked to the POS terminal, and only the voice from microphone 20 is input. Other configuration elements are included in the device in the first exemplary embodiment, and thus, the detailed description thereof will be omitted.

FIG. 12 is a functional block diagram illustrating a schematic configuration of information processing device 40. Detector 41, storage unit 42, and determiner 43 of information processing device 40 are different from those in the first exemplary embodiment.

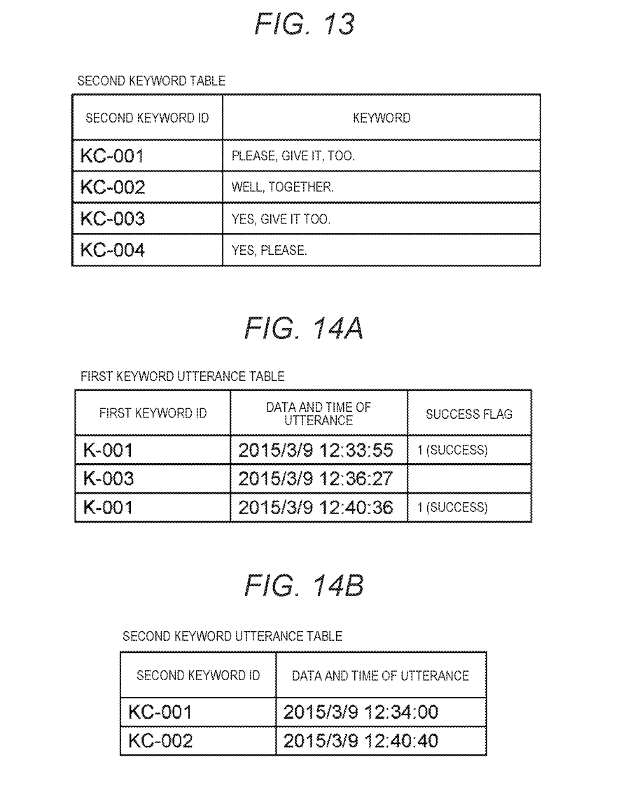

Detector 41 detects a first keyword and a second keyword from the input voices using the voice recognition. Since the detected keyword is stored in the first keyword table in storage unit 14 (refer to FIG. 4) and a second keyword table (refer to FIG. 13) in advance, the detector 41 detects whether or not the keyword stored in these tables is included in the input voices.

Here, the first keyword is a sentence such as “How about potatoes?” used as the up-selling talk by the clerk, which is similar to that in the first exemplary embodiment, and thus, the detailed description thereof will be omitted. The second keyword is a sentence that represents the customer's intention (affirmation) of buying as an answer to the up-selling talk from the clerk, and for example, “Please, give it, too” or “Well, together” is stored in the second keyword table as illustrated in FIG. 13. In addition, an ID (a second keyword ID) assigned to the second keyword is stored together. The second keyword can be arbitrarily added or changed by the manager.

In addition, when the first keyword is detected, detector 41 stores the first keyword ID and the date and time of the utterance in a first keyword utterance table illustrated in FIG. 14A. In addition, in a case where the clerk is identified using the voice recognition, the clerk ID of the clerk who performed the utterance in the first keyword utterance table is also stored. In addition, when the second keyword is detected, detector 41 stores the second keyword ID and the date and time of the utterance in a second keyword utterance table illustrated in FIG. 14B.

Storage unit 42 stores information items such as the first keyword table in FIG. 4, the second keyword table in FIG. 13, the first keyword utterance table in FIG. 14A, and the second keyword utterance table in FIG. 14B.

Determiner 43 compares the content of the first keyword utterance table in 14A and the content of the second keyword utterance table in FIG. 14B, and in a case where the date and time of the utterance is present in the second keyword utterance table within the predetermined time from the date and time of the utterance in the first keyword utterance table, determines that the up-selling talk is successful and stores the success flag “1 (success)” in the first keyword utterance table. Here, in a case the up-selling talk is failed, nothing is stored in the first keyword utterance table, but “0 (fail)” may be stored.

Evaluator 44 aggregates the number of performances of the up-selling talk (number of up-selling talks) and the number of successes of the sales using the up-selling talk (number of successful up-selling talks), and the success rate referring to the first keyword utterance table in FIG. 14A, and then, generates an evaluation table (not illustrated). In a case where the clerk is identified from the voice of the clerk who uttered the first keyword, and the clerk ID is acquired, it is possible to perform the evaluation of each clerk by storing the clerk ID also in the first keyword utterance table. In addition, it is possible to aggregate the evaluation from the date and time of the utterance on a monthly basis.

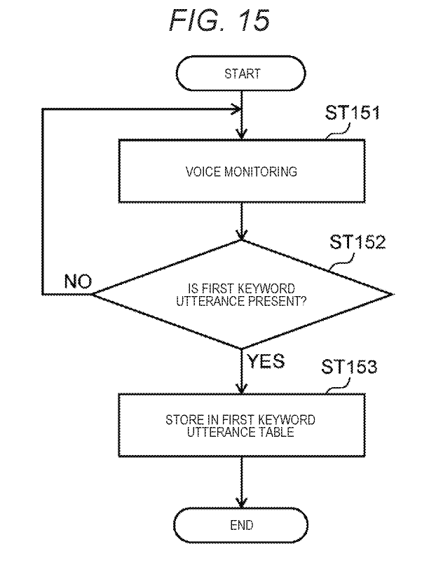

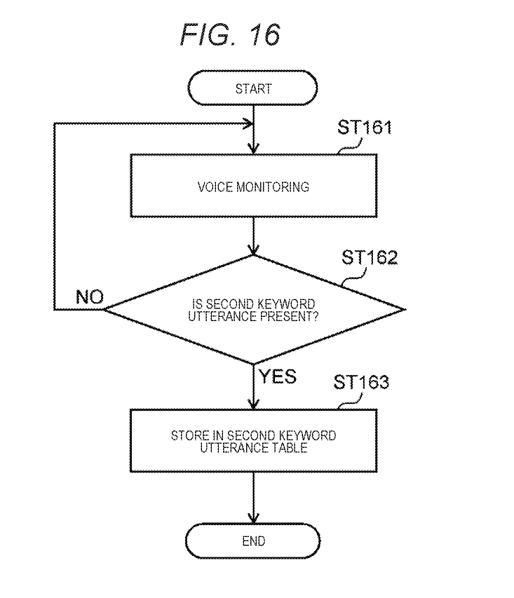

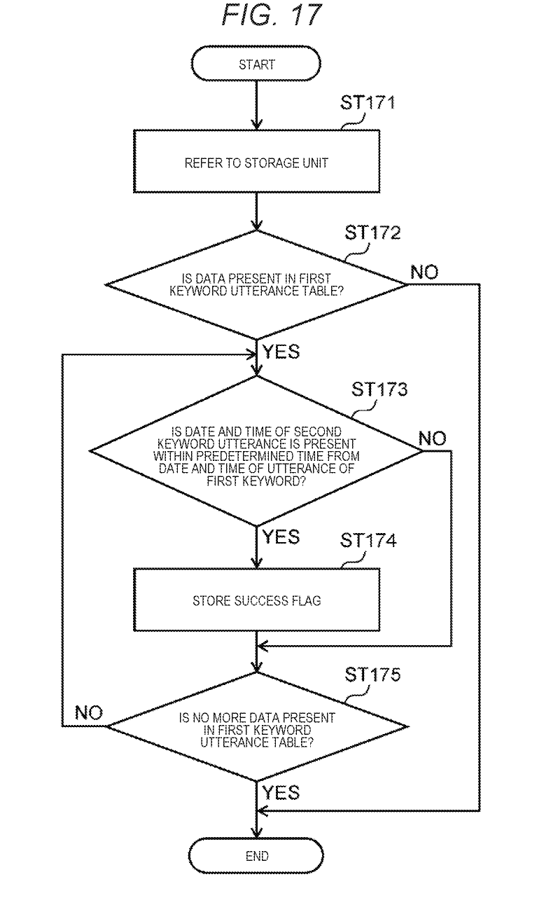

Next, an operational procedure performed by information processing device 40 will be described. FIG. 15 is an operation flowchart illustrating a procedure for detecting a first keyword in the second exemplary embodiment. FIG. 16 is an operation flowchart illustrating a procedure for detecting a second keyword in the second exemplary embodiment. FIG. 17 is an operation flowchart illustrating a procedure for determination of a success or failure of an up-selling talk in the second exemplary embodiment.

In FIG. 15, the voice monitoring is started and the voices collected by microphone 20 is input to voice input unit 11 (ST151). The voice monitoring may be performed all the time during the sales operation in the store.

Next, detector 41 recognizes the input voice, and detects whether or not the first keyword (up-selling talk) stored in the first keyword table in FIG. 4 is included therein (ST152). When the keyword cannot be detected (No in ST152), the process returns to ST151 and continues the voice monitoring.

In ST152, when the first keyword (up-selling talk) is detected (Yes in ST152), detector 41 stores the first keyword ID indicating which keyword stored in the first keyword table is detected and the date and time of the utterance in the first keyword utterance table in FIG. 14A (ST153). In a case where detector 41 identifies the clerk using the voice of the clerk, the clerk ID may also be stored in the first keyword utterance table.

In FIG. 16, detector 41 recognizes the input voice during the voice monitoring (ST161), and detects whether or not the second keyword stored in the second keyword table in FIG. 13 is included (ST162). When the second keyword cannot be detected (No in ST162), the process returns to ST161 and continues the voice monitoring.

In ST162, when the second keyword is detected (Yes in ST162), detector 41 stores the second keyword ID indicating which keyword stored in the second keyword table is detected and the date and time of the utterance in the second keyword utterance table in FIG. 14B (ST163). Although the detection of the first keyword in FIG. 15 and the detection of the second keyword in FIG. 16 are separately described, but both detections may be performed in parallel at the same time.

Next, in FIG. 17, determiner 43 refers to storage unit 42 (ST171), and determines whether or not the data is present in the first keyword utterance table in FIG. 14A (ST172). In a case where the data is not present (No in ST172), it means that the up-selling talk is not performed by the clerk and the process ends.

On the other hand, in a case where the data is present in the first keyword utterance table (Yes in ST172), determiner 43 determines whether or not the date and time of the utterance is present in the second keyword utterance table in FIG. 14B within a predetermined time from the date and time of the utterance of the first keyword (ST173). Here, the predetermined time may be set as a standard time required for the customer to perform a response indicating an agreement after the recommendation saying “How about potatoes?” from the clerk. For example, in a case where the predetermined time is set to 6 seconds, in the first row in the first keyword utterance table in FIG. 14A, the date and time of the first keyword utterance (up-selling talk) is “2015/3/9 12:33:55” in the first row in second keyword utterance table in FIG. 14B and the date and time of the second keyword utterance (response) is “2015/3/9 12:34:00”, and thus, it is determined that the second keyword is uttered within the predetermined time (6 seconds).

In ST173, in a case where it is determined that the second keyword (response) utterance is present within the predetermined time (Yes in ST173), it means that the up-selling talk is successful and “1” is stored in the first keyword utterance table as a success flag (ST174). In a case where it is determined that the second keyword (response) utterance is not present within the predetermined time (No in ST173), it means that there is no additional order due to the up-selling talk, and thus, nothing is stored in the first keyword utterance table, and the process proceeds to ST175. Of course here, for example, “0” may be stored in the first keyword utterance table as a failure flag.

Subsequently, it is determined whether or not a next data is still present in the first keyword utterance table (ST175). In a case where the next data is present in the first keyword utterance table, the process returns to ST173 to repeat the processing.

Specifically describing the above processing, the customer orders “a cheese burger” and “a cup of coffee”. The spontaneous order from the customer is up to here, and the clerk performs the up-selling talk saying “How about potatoes?”. When the performance of the up-selling talk (first keyword utterance) is detected, the date and time of the utterance and the first keyword ID is stored in the first keyword utterance table in FIG. 14A. The first keyword ID acquires an ID corresponding to the detected first keyword from the first keyword table. Upon receiving the up-selling talk, in a case where the customer responds for agreeing with the additional order by saying “Please, give it, too”, the fact that response of this agreement (the second keyword utterance) is performed is detected, and then, the date and time of the utterance and the second keyword ID are stored in the second keyword utterance table in FIG. 14B. The first keyword utterance table and the second keyword utterance table accumulated in this way is compared at the date and time of the utterance, and in a case where the second keyword is stored in the predetermined time, “1 (success)” is stored in the first keyword utterance table in FIG. 14A as a success flag. At this time, as a matter of course, the response from the customer (date and time of the utterance of the second keyword) comes later than the time of the date and time of the utterance of the up-selling talk (first keyword) by the clerk.

Evaluator 44 performs the aggregation processing such as counting the number of success flags “1 (success)” in the first keyword utterance table (refer to FIG. 14A) referring to storage unit 42. Since the number of data items in the first keyword utterance table is the number of performances of the up-selling talks by the clerk, the “number of up-selling talks”, the “number of successful up-selling talks”, and the “success rate” can be calculated from the total number of data items and the number of data items having the success flag “1 (success)”. In addition, in a case where the clerk ID is stored in the first keyword utterance table, it is possible to perform the aggregation for each clerk.

Evaluation information is generated based on the result of aggregation, and the evaluation information is displayed on the monitor screen of information processing device 40 while various processing items such as a graphic display being executed. In addition, the evaluation information can be referred to using the information processing device installed in another store or in the headquarters via the network.

### Third Exemplary Embodiment

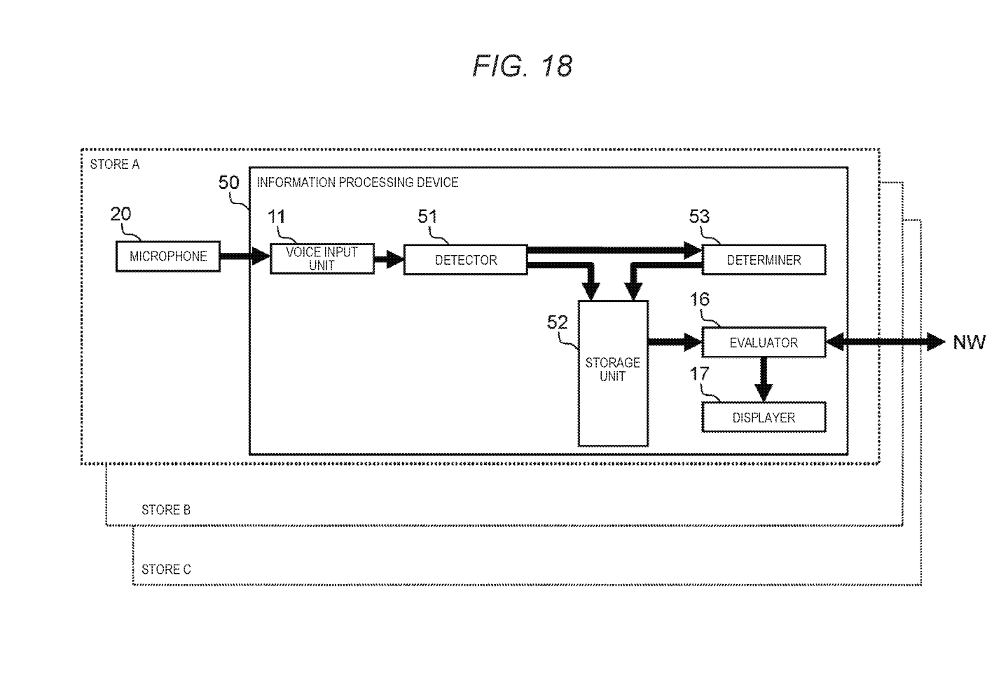

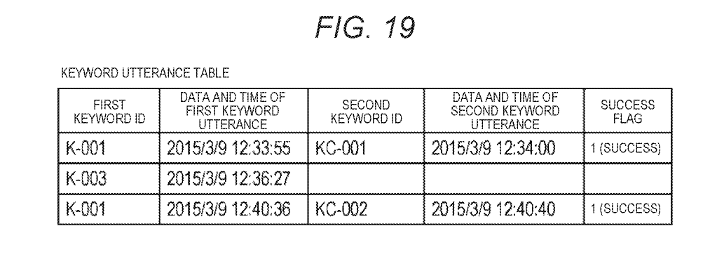

FIG. 18 is a functional block diagram illustrating a schematic configuration of information processing device 50 in a third exemplary embodiment. FIG. 19 is an explanatory diagram illustrating a content of a table in the third exemplary embodiment.

Information processing device 50 in the third exemplary embodiment is not linked to the POS terminal, and only the voice from microphone 20 is input similarly to the device in the second exemplary embodiment, but it is different from the device in the second exemplary embodiment in point that the detection and the determination of the keyword are performed in real time. The configuration elements included in the second exemplary embodiment will be omitted.

Detector 51 detects the first keyword and the second keyword from the input voices by the voice recognition. The first keyword and the second keyword are the same as those in the second exemplary embodiment.

When the first keyword is detected, detector 51 notifies determiner 53 of the fact that the first keyword is detected. In addition, detector 51 stores the first keyword ID, the date and time of the utterance of the first keyword in the keyword utterance table illustrated in FIG. 19. At this time, in a case where the clerk is identified by the voice recognition, the clerk ID of the clerk who performed the utterance in the keyword utterance table may be stored.

In addition, when the second keyword is detected, detector 51 notifies of determiner 53 of the fact that the second keyword is detected. In addition, detector 51 stores the second keyword ID and the date and time of the utterance of the second keyword in association with the first keyword stored immediately before in the keyword utterance table illustrated in FIG. 19. In the example here, the storage is collectively performed in one table. However, similarly to the second exemplary embodiment, the storage may be separately performed in the first keyword utterance table and the second keyword utterance table.

Storage unit 52 stores the information items such as the first keyword table in FIG. 4, the second keyword table in FIG. 13, and the keyword utterance table in FIG. 19.

When the notification of the fact that the first keyword is detected is received from detector 51, determiner 53 starts time counting, and determines whether or not the notification of the fact that the second keyword is detected is received from detector 51 within the predetermined time. In a case where the notification is received, it is determined that the up-selling talk is successful and “1 (success)” is stored in the keyword utterance table as a success flag.

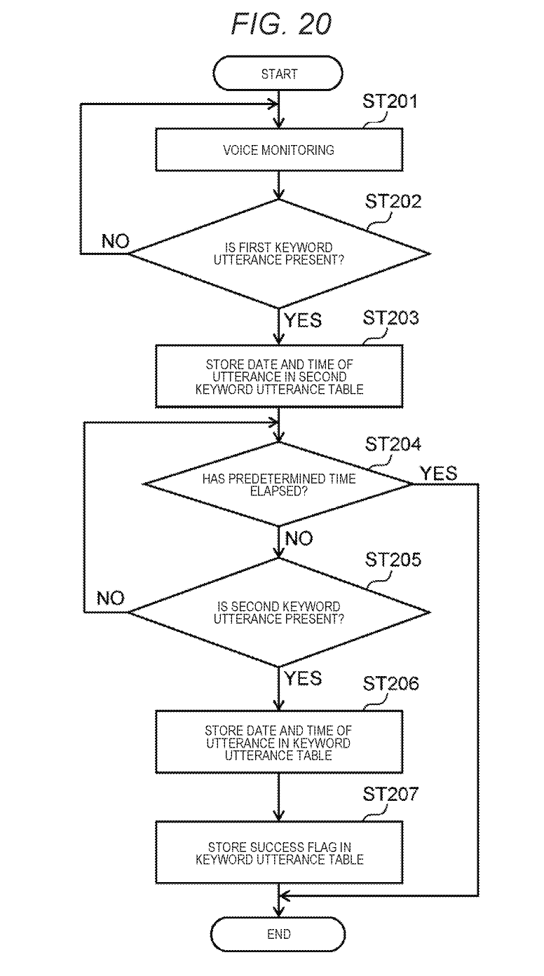

Next, an operational procedure performed by information processing device 50 will be described. FIG. 20 is an operation flowchart illustrating a procedure for determination of a success or failure of an up-selling talk in the third exemplary embodiment.

In FIG. 20, the voice monitoring is started and the voices collected by microphone 20 is input to voice input unit 11 (ST201). The voice monitoring may be performed all the time during the sales operation in the store.

Next, detector 51 recognizes the input voice, and detects whether or not the first keyword (up-selling talk) stored in the first keyword table in FIG. 4 is included therein (ST202). When the keyword cannot be detected (No in ST202), the process returns to ST201 and continues the voice monitoring.

In ST202, when the first keyword (up-selling talk) is detected (Yes in ST202), detector 51 notifies determiner 53 of the fact that the first keyword is detected and stores the first keyword ID and the date and time of the utterance of the detected keyword in the keyword utterance table in FIG. 19 (ST203). In a case where detector 51 identifies the clerk using the voice of the clerk, the clerk ID may also be stored in the keyword utterance table.

Next, determiner 53 monitors that the predetermined time has elapsed from the reception of the notification of the fact that the first keyword is detected (ST204), and when the predetermined time has elapsed (Yes in ST204), it means that the second keyword (customer's response of intention of buying) is not present, and thus, the process ends.

In addition, detector 51 recognizes the input voices, and detects whether or not the second keyword (customer's response of agreement to buy) is included in the second keyword table in FIG. 13 (ST205). When the second keyword cannot be detected (No in ST205), the process returns to ST204 and continues the voice monitoring.

In ST205, when the second keyword is detected (Yes in ST205), detector 51 notifies determiner 53 of the fact that the second keyword is detected and stores the second keyword ID, date and time of the utterance of the detected keyword in association with the first keyword in the keyword utterance table in FIG. 19 (ST206).

Next, when the notification of the fact that the second keyword is detected is received from detector 51 within the predetermined time, determiner 53 stores “1 (success)” as a success flag in association with the first keyword in the keyword utterance table in FIG. 19, and then, the process ends.

Specifically describing the processing, the customer orders “a cheese burger” and “a cup of coffee”. After the spontaneous order from the customer, the clerk performs the up-selling talk saying “How about potatoes?”. When the performance of the up-selling talk (first keyword utterance) is detected, time counting is started and the date and time of the utterance and the first keyword ID is stored in the keyword utterance table in FIG. 19. Upon receiving the up-selling talk, in a case where the customer responds for agreeing with the additional order by saying “Please, give it, too”, the fact that response of this agreement (the second keyword utterance) is performed within the predetermined time is detected, and then, “1 (success)” is stored as a success flag. In addition, the date and time of the utterance and the second keyword ID are stored in the keyword utterance table.

In the present exemplary embodiment, the success or failure of the up-selling talk is determined in real time during the voice monitoring between the clerk and the customer. However, date and time of the utterance and the keyword ID may be omitted to be stored in the keyword utterance table in FIG. 19, and only the presence or absence of the success may be stored.

### Fourth Exemplary Embodiment

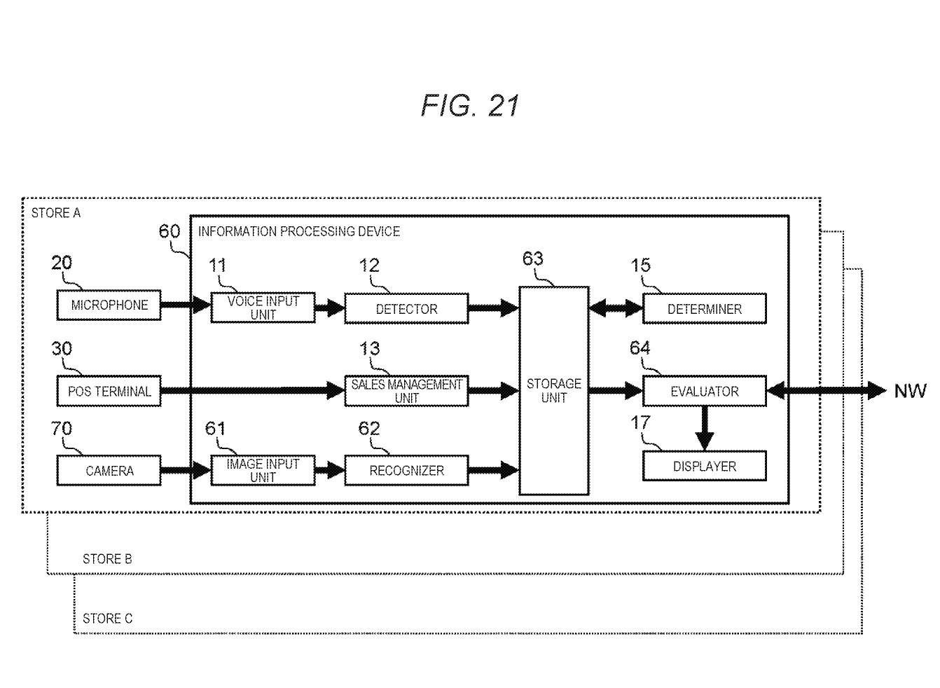

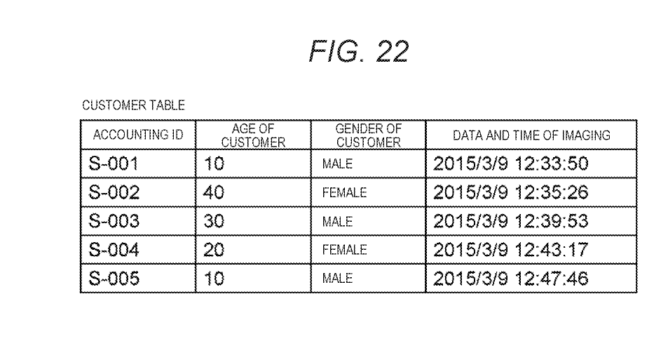

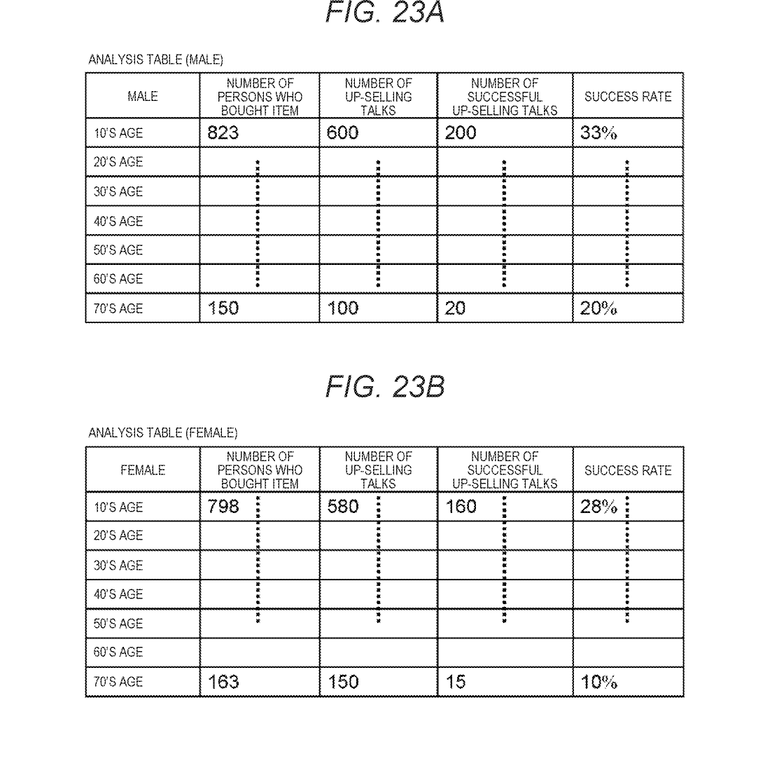

FIG. 21 is a functional block diagram illustrating a schematic configuration of information processing device 60 in a fourth exemplary embodiment. FIG. 22 and FIGS. 23A and 23B are explanatory diagrams illustrating a content of a table in the fourth exemplary embodiment respectively.

In the fourth exemplary embodiment, camera 70 capable of imaging the surroundings of the POS terminal is provided in the store. The fourth exemplary embodiment is different from the first exemplary embodiment in a point that information processing device 60 in the fourth exemplary embodiment includes image input unit 61, recognizer 62 that recognizes the image, storage unit 63 that stores attribute information relating to a customer, and evaluator 64 that performs evaluation using the attribute information relating to the customer. The description for the configuration elements included in the first exemplary embodiment will be omitted.

Image input unit 61 inputs the image input from camera 70. It is assumed that camera 70 images the customer positioned in front of the POS terminal.

Recognizer 62 extracts, for example, an image of the ordering customer from the image input from image input unit 61, recognizes the attributes such as an age or gender of the customer using the image recognition, and stores the result in a customer table illustrated in FIG. 22. At this time, the date and time of imaging is also stored in addition to the attributes such as the age and gender which are the result of recognition. In addition, the accounting ID may be acquired from the sales table by collating the date and time of imaging with the date and time of the sales in the sales table in FIG. 6A, and then, the accounting ID may be stored in the customer table. In addition, in a case where family members such as accompanied children are obtained from the image, the family members may be the attribute of the customer. In addition, emotions (joy, anger, sadness, and delight) of the customer may be extracted by recognizing the face image of the customer, and then, the emotion may be the attribute of the customer. In addition, customer's body shape or the item preferences may be the attribute of the customer.

Storage unit 63 stores information items such as the customer table in FIG. 22 and analysis tables in FIGS. 23A and 23B in addition to the various tables used in the first exemplary embodiment.

Evaluator 64 aggregates and evaluates the presence or absence of the success of the up-selling talks similarly to the first exemplary embodiment, and analyzes a customer level of the visited customer. In addition, evaluator 64 aggregates the presence or absence of the successful up-selling talks for each age and gender, and then, generates the analysis table illustrated in FIGS. 23A and 23B based on the age and gender for which the up-selling talk is easily succeed.

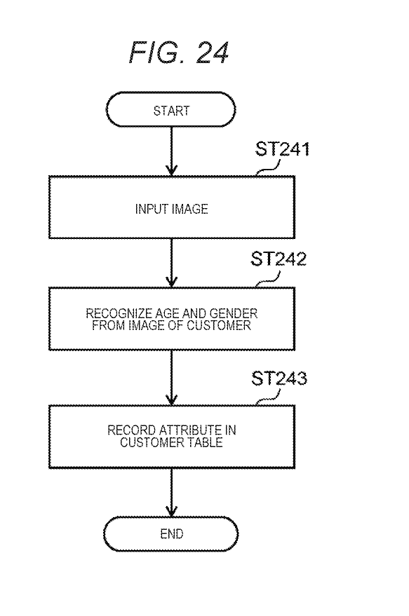

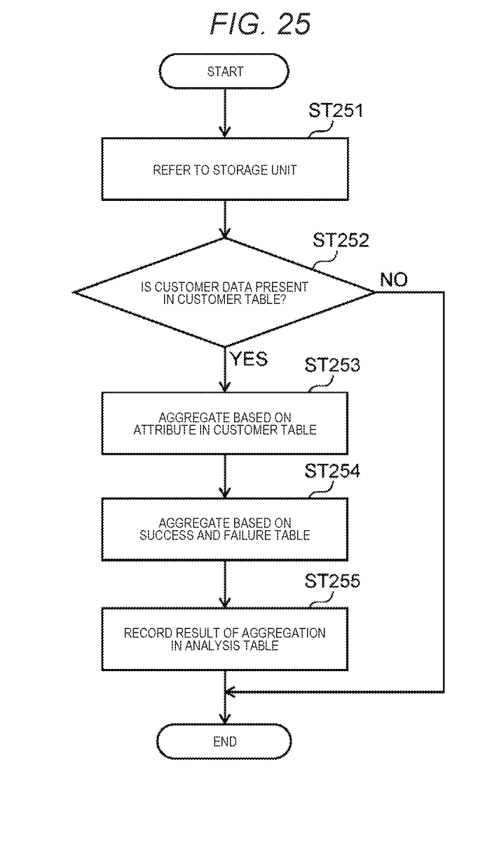

Next, an operation procedure performed by information processing device 60 will be described. The detection of the keyword or the determination of the success or failure of the up-selling talk is similar to that in the first exemplary embodiment, and thus, the description thereof will be omitted. FIG. 24 is an operation flowchart illustrating a procedure for acquiring customer information in the fourth exemplary embodiment, and FIG. 25 is an operation flowchart illustrating a procedure for aggregating data in the fourth exemplary embodiment.

In FIG. 24, an image of a customer in front of the POS terminal is input from the camera (ST241). The timing of the image of the customer being input may be a time when new accounting processing is started in the POS terminal (when an accounting ID is assigned) or may be a time when an order from the customer or an up-selling talk from the clerk is detected by the voice monitoring, or the image may be input all the time during the sales operation in the store.

Next, recognizer 62 acquires the attributes such as the age or gender of the customer from the input image by extracting the customer and performing the image recognition using a known method (ST242). The acquired attributes are stored in the customer table in FIG. 22 (ST243). Processes ST242 and ST243 may be performed in every time the customer order, or the image may be stored in advance, and later, the acquisition of the attributes and storing in the customer table may be collectively performed using the image recognition.

In FIG. 25, evaluator 64 refers to storage unit 63 (ST251), and determines whether or not customer data is present in the customer table (refer to FIG. 22) stored in storage unit 63 (ST252). In a case where the customer data is not present (No in ST252), it means that the image recognition is not performed, and the process ends.

On the other hand, in a case where the customer data is present in the customer table (Yes in ST252), the number of purchasers is aggregated for each age, gender, or the date and time of imaging, and then, an aggregation data in which the customer level is analyzed is generated (ST253). In this way, it is possible to obtain the aggregation data for each store such as the number of purchasers for each age and gender, the number of purchasers for each day and time frame. In addition, by collating the item ID of the sales data, it is possible to know the items of which the number of purchases is large for each age and gender.

Next, the attribute of the customer is extracted from the customer data in the customer table having the date and time of imaging nearest to the date and time of the utterance of the first keyword in the success and failure table (refer to FIG. 6B), and the attribute of the customer is aggregated as the attribute of the customer to whom the up-selling talk is performed by the clerk (ST254). Since the number of data items in the success and failure table is the number of up-selling talks performed by the clerk, “the number of up-selling talks”, “the number of successful up-selling talks”, and “the success rate” can be calculated from the total number of data items, the number of data items having the success flag “1 (success)”, and the attributes of the customer in the customer table for each age of male or for each age of female as illustrated in FIGS. 23A and 23B, and then, the analysis table can be generated (ST255). In addition, since the item IDs are stored in the success and failure table, by collating these item IDs with the item table (refer to FIG. 5B), it is possible to calculate the success amount due to the successful up-selling talk.

In addition, the attributes of the customer can be extracted from the customer data in the customer table having the date and time of imaging nearest to the date and time of the utterance of which the success flag in the success and failure table (refer to FIG. 6B) is “1 (success)”, and aggregates the attributes of the customer as the attribute of the up-selling talk successful customer. In addition, since the clerk ID and the date and time of the utterance are stored in the success and failure table, it is possible to perform the aggregation on a clerk basis or on a monthly basis from these information items.

It is possible to generate the analysis table (evaluation information) illustrated in FIGS. 23A and 23B based on the result of aggregation. The evaluation information can be displayed on the monitor screen of information processing device 60 while various processing items such as a graphic display being executed. In addition, the evaluation information can be referred to using the information processing device installed in another store or in the headquarters via the network.

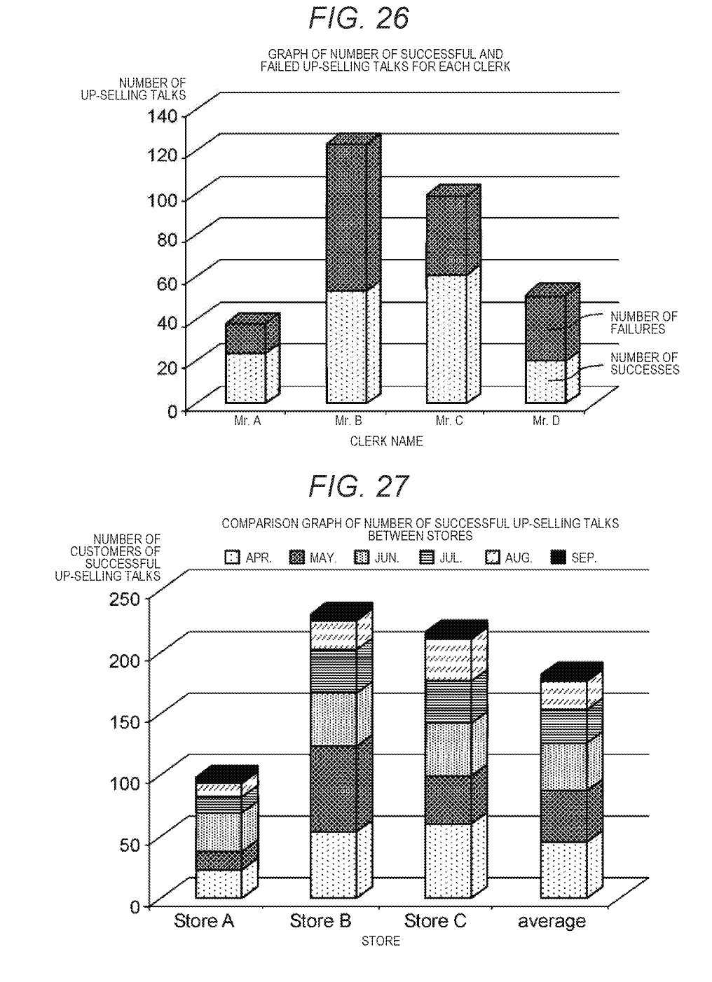

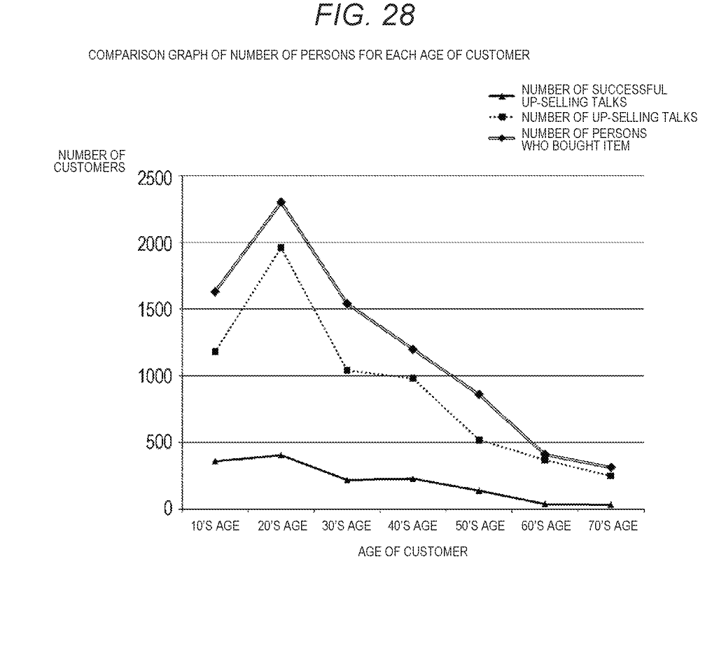

Next, an example of the evaluation information displayed on the monitor screen of information processing device 60 will be described. FIG. 26 is an explanatory diagram illustrating an example of a screen displaying a data aggregation result in the first to fourth exemplary embodiments. In addition, FIG. 27 is an explanatory diagram illustrating an example of a screen displaying a data aggregation result in a plurality of stores in the first to fourth exemplary embodiments. FIG. 28 is an explanatory diagram illustrating an example of a screen displaying a data aggregation result in the fourth exemplary embodiment.

According to the first to fourth exemplary embodiments, as illustrated in FIG. 26, the number of successful up-selling talks and the number of failed up-selling talks can be displayed in a graph for each clerk. In this way, the clerk who actively performs the up-selling talk and the clerk who increases the sales due to the up-selling talks can be clarified, and thus, it is possible to evaluate the customer service by the clerk using these information items. In addition, with regard to the clerk having a large number of successful up-selling talks, the monitored voice of up-selling talks by the clerk may be used as a model when educating other clerks.

In addition, as illustrated in FIG. 27, the number of successful up-selling talks can be displayed in a graph for each store in monthly basis. In this way, the supervisor in the headquarters who manages a plurality of stores can grasp the stores that actively promote the up-selling talk and the stores that increase the sales due to the up-selling talks, and can evaluate the stores using these information items. In addition, the information items can be used for educating the stores of which the number of performances of the up-selling talks or the number of successful up-selling talks is small.

In addition, according to the fourth exemplary embodiment, as illustrated in FIG. 28, the number of successful up-selling talks, the number of performances of up-selling talk, and the number of persons who bought the items can be displayed in a graph for each age of the customer. In this way, for which ages of the customer the up-selling talk is effective can be grasped, and it is possible to use the information for actively performing the up-selling talk particularly to the customers of such ages for the sales promotion. In addition, from a relation between the item of successful up-selling talk and the ages of the customer, the age of the customer can be used for changing the recommendation of the items.

As above, the present disclosure is described based on specific exemplary embodiments, but the exemplary embodiments are just examples, and the present disclosure is not limited by the exemplary embodiments. In addition, each configuration element of the sales management device according to the present disclosure described in the exemplary embodiment, the sales management system and the sales management method are not necessarily essential and can appropriately be selected without being deviated from the scope of the present disclosure.

For example, in the present exemplary embodiments, the description is made with the example of a store such as the hamburger shop, but not limited to such a store, and it can be applied to a store of other business types.

In addition, in the first exemplary embodiment, the sales data is input to information processing device 10 from POS terminal 30. However, the sales data may be transmitted to a POS-dedicated server (not illustrated) from POS terminal 30, and then, transmitted to information processing device 10 from the POS-dedicated server. In addition, the POS-dedicated server and information processing device 10 may be configured as an integrated device.

In addition, by causing POS terminal 30 to have each function of information processing device 10, the functions similar to that in the first exemplary embodiment can be realized only with the configuration of POS terminal 30 and microphone 20. Furthermore, if a microphone is built in or externally attached to POS terminal 30, the functions similar to that in the first exemplary embodiment can be realized only with POS terminal 30. In addition, in this case, a part of functions such as the voice recognition processing for detecting the keyword may be performed by an external server.

In addition, in the present exemplary embodiment, the processing necessary for monitoring the voice or image is performed by the information processing device provided in the store. However, the necessary processing may be performed by the information processing device provided in the headquarters or by a cloud computer configuring a cloud computing system. In addition, the necessary processing may be shared by a plurality of information processing devices, and information may exchanged between the plurality of information processing devices via a communication medium such as an IP network or LAN. In this case, sales management systems are configured in the plurality of information processing devices that share the necessary processing.

In this configuration, among the processing items necessary for the store management at least the processing having a large data amount, for example, the voice recognition processing or the image recognition processing may be performed by the information processing device provided in the store. In this configuration, since the remaining processing items have a small data amount, even if the remaining processing items are performed by the information processing device provided in a place other than the store, for example, by the information processing device provided in the headquarters, because the communication load can be reduced, it is possible to make it easy to operate a system having wide area network connection configuration.

All the necessary processing items may be performed by a cloud computer or at least the screen output processing among the necessary processing items may be shared by the cloud computer. In this configuration, besides the information processing devices provided in the store and headquarters, the monitoring image, the monitoring voice, and the evaluation information screen of the store can be displayed on a mobile terminal such as a smart phone or a tablet terminal, and it is possible for a supervisor patrolling the stores to manage the sales situation of the remote store at an arbitrary place such as outside of the store or the headquarters.

In addition, in the description in the present exemplary embodiment, the necessary processing is performed by the information processing device installed in the store, and the evaluation information screen or the like is displayed on the monitor connected to the information processing device, and then the necessary input or output is performed by the information processing device. However, the necessary input or output may be performed by a separated information processing device, for example, the information processing device installed in the headquarters or a mobile terminal such as a smart phone or a tablet terminal.

### INDUSTRIAL APPLICABILITY

A sales management device, a sales management system and a sales management method disclosed in the present disclosure detect whether or not a first keyword is included in a voice input to a voice input unit, and determine whether or not sales data is stored within a predetermined time from the time when it is detected that the first keyword is included, and then, manage a correlation between the predetermined keyword and the sales performance of the items. In this way, it is effective for evaluating whether a customer buy the items due to a so-called up-selling talk, in which a clerk recommends that the customer buy some items, and thus, it is useful as the sales management device, the sales management system, and the sales management method which manage the correlation between the voices of the clerk when receiving a customer and the sales performance.

### REFERENCE MARKS IN THE DRAWINGS

10, 40, 50, 60 information processing device
20 microphone
30 POS terminal
11 voice input unit
12, 41, 51 detector
13 sales management unit
14, 42, 52, 63 storage unit
15, 43, 53 determiner
16, 44, 64 evaluator
17 displayer
61 image input unit
62 recognizer
70 camera

1-13. (canceled)

14. A sales management device comprising:
a voice input unit that inputs a voice from a microphone in a store;
a sales management unit that inputs sales data of the store;
a storage unit that stores the sales data;
a detector that detects whether or not a first keyword is included in the voice input to the voice input unit; and
a determiner that determines whether or not the sales data is stored in the storage unit within a predetermined time from the time when it is detected by the detector that the first keyword is included.

15. A sales management device comprising:
a voice input unit that inputs a voice from a microphone in a store;
a sales management unit that inputs sales data of the store;
a storage unit that stores the sales data;
a detector that detects whether or not a first keyword is included in the voice input to the voice input unit; and
a determiner that determines whether or not the sales data of an item corresponding to the first keyword is stored in the storage unit in an accounting at the time when it is detected by the detector that the first keyword is included.

16. A sales management device comprising:
a voice input unit that inputs voices of a clerk and a customer from a microphone in a store;
a detector that detects whether or not a first keyword is included in the voice of the clerk and detects whether or not a second keyword is included in the voice of the customer; and
a determiner that determines whether or not it is detected that the second keyword is included within a predetermined time from the time when it is detected that the first keyword is included.

17. The sales management device of claim 14,
wherein the first keyword includes a recommended item name for the customer to be recommended to buy.

18. The sales management device of claim 16,
wherein the second keyword is a word affirming to buy the recommended item to the clerk.

19. The sales management device of claim 14,
wherein the predetermined time is a time to finish one accounting.

20. The sales management device of claim 14, further comprising:
an evaluator that evaluates a clerk based on a result of determination by the determiner.

21. The sales management device of claim 14, further comprising:
an evaluator that evaluates a clerk;
an image input unit that inputs an image of a customer from a camera in a store; and
a recognizer that recognizes attributes of the customer based on the image,
wherein the evaluator aggregates the results of determination by the determiner for each attribute.

22. A sales management system comprising:
a microphone that collects voices in a store; and
an information processing device that includes a processor and a memory,
wherein the information processing device includes
a voice input unit that inputs a voice from a microphone in the store,
a sales management unit that inputs sales data of the store,
a storage unit that stores the sales data,
a detector that detects whether or not a first keyword is included in the voice input to the voice input unit, and
a determiner that determines whether or not the sales data is stored in the storage unit within a predetermined time from the time when it is detected by the detector that the first keyword is included.

23. A sales management method comprising:
detecting whether or not a first keyword including a recommended item name is included in a voice of a clerk input from a microphone in a store; and
determining whether or not sales data of an item corresponding to the first keyword is stored within a predetermined time from the time when it is detected that the first keyword is included in the voice of the clerk.
